(19) United States
(12) Patent Application Publication
(10) Pub. No.: US 2005/0232824 A1
(43) Pub. Date: Oct. 20, 2005

(54) High temperature electrolyte testing container

(76) Inventor: Robert A. Pangrcic, LaSalle, IL (US)

Correspondence Address: Robert Pangreic, 1104 5th Street, LaSalle, IL, 61301, US

(21) Appl. No.: 10/824,281

(22) Filed: Apr. 14, 2004

(51) Int. Cl. B01L 3/00

(52) U.S. Cl. 422/102; 422/56

(57) ABSTRACT

A container in which minerals such as silica are prepared for testing or are tested in a thermo-electrolytic process includes bottom and sides for containing a corrosive electrolyte, such as, a sulfuric or hydrochloric acid solution. The bottom and the sides of the container are composed of a high heat resistant cured mixture of graphite or graphite composite material. The sides form a pouring spout. The container has a removable cover.

### BACKGROUND OF THE INVENTION

1. Field of the Invention

This invention relates generally to the material testing area. More specifically it relates to testing of materials in high temperature environments, specifically in when acidic or basic compounds are present.

2. Description of the Prior Art

In sand mining operations, it is necessary to determine the type of sand being mined. Different sands have different end uses. One of the tests that is commonly performed on sand is spectrographic analysis. From a spectrograph one can determine the components of the sand. This is accomplished by shining light through the sand, and recording the frequencies of light that pass through and the frequencies of light that do not pass through and recording the intensities of the light at each frequency. By comparing the frequency and intensity data with known values, the components of the sand are quickly and easily determined. In order to perform the test, the silica sand should be separated from the other components. Usually, this separation process is performed by adding an electrolyte to the sand. The electrolyte, typically a strong acid; for example hydrofluoric acid, nitric acid, sulfuric acid, or hydrochloric acid, reacts with the silica. The acid-silica mixture is then heated so that the liquid vaporizes whereby a residue is left. The residue typically forms into crystals whereupon the crystalline residue is reliquified and subjected to the aforementioned spectrographic process. In order to perform the test, a container that is acid and heat resistant is provided. One such prior art container has a three-piece construction that has been used in the industry.

The prior art shown in FIG. 1 shows a container 12 that is used to test silica. It has three primary parts: a graphite base 10 having a coating 20 thereon, a tube 30 having Teflon walls forming an interior cavity 32 defined by the tube 30 and a ring 40 that connects the tube 30 to the base 10. An adhesive is applied to an inner surface 42 of ring 40 to connect tube surface 34 of tube 30 to the ring 40. Additionally the inner surface 42 of ring 40 adheres to circumferential surface 14 of base 10. Because of the reactivity of the graphite base 10 with various acids, it must have the coating 20 on it. One disadvantage of the prior art is that the coating 20 is only applied to a side of the base 10 in regular contact with acid for fabrication and material cost reasons. Because the coating is only on one side of the base, the base 10, ring 40 and adhesive is often exposed to acid because the acid inside the container often spills onto the burner, laps over the edge of the container and runs down to the base, or boils over and splashes the exterior of the container. Additionally, the vapor from the acid also damages the container. The result of the contact between the container and the acid, including acid vapors, causes etching, erosion, and deterioration of the adhesive or other parts of the container, all of which may result in a catastrophic failure of the container.

Another disadvantage of the prior art is that because of the type of tube used, the container can only withstand maximum temperatures of about 500 degrees Fahrenheit. Because of the low maximum temperature of the container, it takes long periods of time to reduce the acid/sand mixture to a crystalline residue. If the container could withstand higher heat, the testing process could be sped up. Still another disadvantage of the invention is that inexperienced or absentminded testers often exceed the maximum temperature of the prior art container whether by adjusting the temperature control to a temperature that exceeds the melting point of the container or who leave the container unattended on the burner or hotplate for extended periods of time. In either case, often all that remains is the melted container that used to be the prior art. Another shortcoming of the prior art is that the melting very often occurs when acid and silica are still in the container 12. When the container melts the acid and sand spill causing very serious damage and creating an environmental problem.

And still another disadvantage of the prior art is the rate of heat transfer through the container to the contents of the container.

Yet another disadvantage of the prior art is that the adhesive that seals ring 40 to the base 10 to the tube 30 often fails. This failure may be catastrophic or incremental. If it is catastrophic, the contents of the container may suddenly evacuate the container, causing serious damage to anything in the vicinity. Alternatively, if the failure is incremental, the contents may leak out slowly, leaving highly acidic silica in its path.

And yet still another disadvantage of the prior art is the unbonding of coatings to the prior art container.

### SUMMARY OF THE INVENTION

The present invention recognizes and addresses the foregoing disadvantages, and other prior art methods.

Accordingly, it is an object of the invention to provide a new and improved container for testing materials subject to high heat and/or electrolytic or caustic materials. Another object of the invention is to provide containers for testing materials that are relatively more economical than prior art containers.

A further object of the invention is to provide a container for preparing materials for testing wherein the likelihood of catastrophic failure of the container spilling the contents is minimized. Yet another object of the invention is to provide a container for the faster testing of materials.

A still further object of the invention is to provide a container for testing sand or other materials in the presence of electrolytic materials that has a longer life than the prior art. Another object of the invention is to provide a container for testing materials in the presence of electrolytic materials that permits testing at higher temperatures, at lower pHs or higher molarities. And another object of the present invention is to provide a testing container that is easier to clean.

A further object of the invention is to provide a container for testing materials in the presence of electrolytic materials in which improved productivity and quality can be obtained without adversely affecting the performance or useful life of the container. And still another object of the invention is to provide a container for testing materials in the presence of electrolytic materials that permits the elimination of assembly time. And yet still another object of the invention is to provide a container to which coatings better adhere.

These and other objects of the present invention are achieved by providing a container for preparing materials for testing. Typically, the container will be subject to high heat and strong acids or bases. The container, made of a graphite composite, is preferably of a single piece construction. The container has a base, sides and a top. A spout may also be formed in the sides and top. The container may have a handle. The handle may be permanent or removably attached. The container should be resistant to temperatures up to at least 700 degrees Fahrenheit.

In general terms, one aspect of the invention comprises a container for an electrolytic process consisting of a cured graphite composite. Graphite composites can be found having especially high mechanical strength, electrical resistance, isotropic properties, acid resistance, heat resistance or resistance to oxidation. Additionally, the graphite container is preferably isostatically pressed. It is therefore unnecessary to check on pressing direction or graphite grain. When designing molds it is essential to bear in mind the electrical and thermal values of any graphites used.

Another exemplary embodiment is a container made of a graphite composite that is coated with a non-reactive coating to prevent reactions of the graphite composite with certain electrolytic substances including perchloric acid and hydrofluoric acid. The coating will permanently bonded with the container.

Additional objects and advantages of the invention are set forth in the detailed description herein, or will be apparent to those of ordinary skill in the art. Also it should be appreciated that modifications and variations to the specifically illustrated and discussed structure may be practiced in various embodiments and uses of this invention without departing from the spirit and scope thereof, by virtue of present reference thereto. Such variations may include but are not limited to, substitution of equivalent structure for those shown or discussed and the repositioning of various elements, or the like.

### DESCRIPTION OF THE DRAWINGS

FIG. 1 is an exploded view of the prior art;

FIG. 2 is a perspective view of the subject invention;

FIGS. 3a, 3b and 3c are cross-sectional views of various embodiments of the invention;

FIGS. 4a, 4b, 4c and 4d are perspective views of various types of handles according to the invention;

FIG. 5 is a top plan view of the invention;

FIG. 6a is a top view of the container and lid; and

FIG. 6b is a section view of 6a taken along section lines a-a.

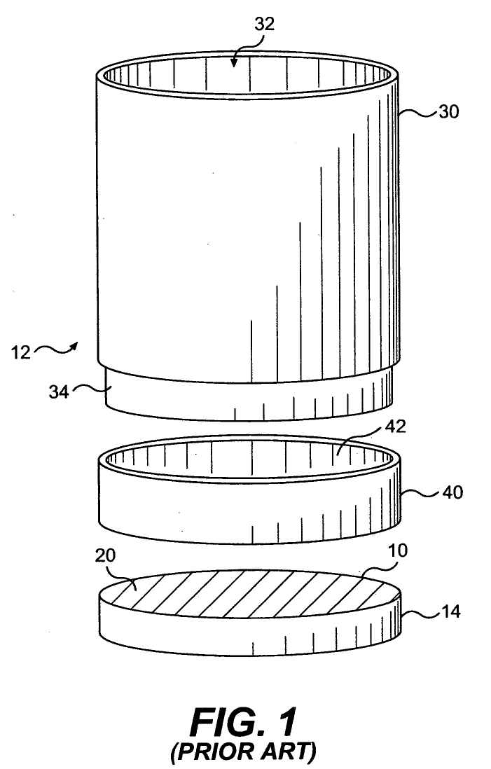

### DETAILED DESCRIPTION OF THE PREFERRED EMBODIMENTS

It is to be understood by one of ordinary skill in the art that the present discussion is a description of exemplary embodiments only and is not intended as limiting the broader aspects of the present invention. The broader aspects are embodied in the exemplary construction.

In general, the present invention is directed to a container for testing substances in the presence of electrolytes or strong acids or bases. The container is made of a non-reactive graphite or graphite composite material. Some of the substances that are tested include what is commonly know as sand, sand mixtures, silica and silica composites, and unidentified substances (wherein the purpose of the test is to identify the substance). Other substances may also be tested. Hereinafter, the substances will generically be referred to as sand, but is in no way limited to sand or materials.

The material used to make the container may be altered to have different reactive properties based on an intended use. For example, if electrolyte present in the container is nitric, nitrate, sulfiric, hydrofluoric or hydrochloric acid, a material such as R7510 manufactured by Ascarbon should be used. If an electrolyte such as perchloric acid is present, either a nonreactive coating such as Teflon should be applied to the container or a different container material that does not react with the electrolyte should be used as the material to form the container. Teflon comes in a variety of variants. Preferably a low temperature but highly adhesive Teflon or other coating such Teflon PFA should be used. However, it is within the scope of the invention to also use high temperature coating including other Teflon coatings. Preferably the coating should not be applied to the bottom of the container so that it does not melt or unadhere itself from the container either completely or in part.

Typically, the electrolyte present in the container is a strong acid with a low pH. The molarity of the electrolyte may vary. Some of the electrolytes that were tested in containers of the subject invention were sulfuric acid, hydrochloric acid, bromic acid, nitric acid, hypochlorous acid and perchloric acid solutions.

The graphite composite that is made into the container according to the preferred embodiment of the present invention may comprise many different substances. Regardless of the composition of the graphite composite, the graphite composite preferably has properties that fall within following ranges. The graphite composite has a thermal conductivity of 30-130 W/(m*K). Preferably the range of thermal conductivity is between 80 and 120 W/(m*K). Additionally, the compressive strength of the graphite composite necessary to form the container shall be between about 70 and 170 N/mm². Preferably the compressive strength is within about 100 and 150 N/mm². The Young's Modulus of the graphite composite should be about 8-15*10³ N/mm² and is preferably about 11.5*10³ N/mm². The bulk density of the graphite composite should be about 1.6 to 2.0 g/cm³ and is preferably about 1.83. Preferably R7510 is used to make the container, but there are many other composites that would be suitable and are within the scope of this invention.

The container may be formed through a variety of processes. Preferably, container is machined from a single piece of bar or round stock; however it is possible to form the container with an injection molding process, a single pour process, or other processes. The container is preferably is of one-piece construction; however, a lid and handle may be separately formed and then attached as necessary. The single piece construction of the container prevents leakage between parts which was one of the major disadvantages of the prior art. The multiple parts often resulted in improper connections and undue which caused leakage and catastrophic failure of the prior art containers. Additionally, electrolytic containers must be nonporous, possess sufficient mechanical strength to withstand small impacts and resist chipping and be chemically inert relative to the electrolyte or other chemicals, elements or compositions present.

Generally, the container has a bottom, a top and sides that form an internal cavity in which material may be placed for testing. The top has an opening in it that allows communication between the internal cavity and outside the beaker. The sides generally form a tube. Preferably, the transition between the sides and the bottom of the container is a gradual one having no angles. Preferably the transition area is generally curved.

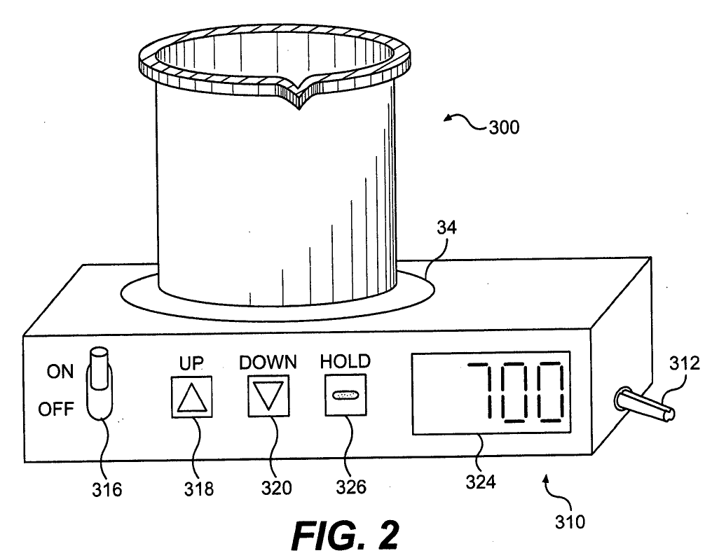

FIG. 2 shows the subject invention in use. Container 300 is placed on heating device 310 preferably a hot plate or burner. The hotplate 300 typically has a heating element 314. It will preferably have a temperature control 318 and 320 and a temperature display 324. The temperature control allows the operator to adjust the temperature either up or down or even hold the temperature with a hold button 326. The heating device may be electric. An electric heating device will have an electrical cable 312 for plugging into an electrical outlet that provides electricity to the electrical heating device 310. An electrical heating device preferably has an “on/off” switch 316.

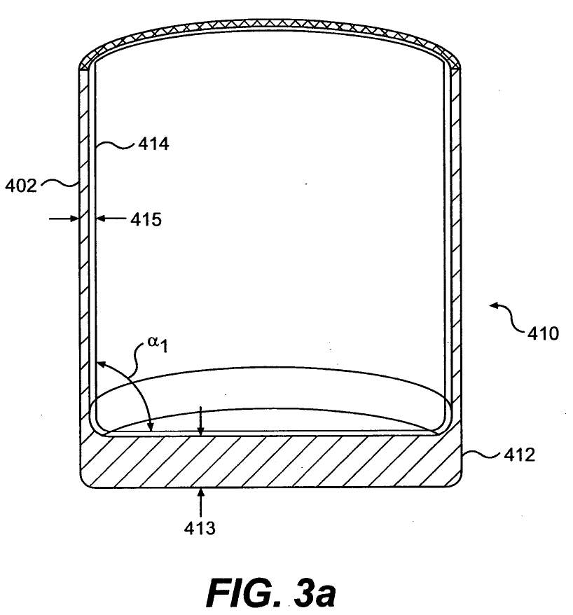

FIGS. 3a, 3b and 3c show three different embodiments of the present invention. The differences in the three embodiments are based in the design of container and are based on the intended use of the container. The base 412 of all three designs is preferably generally cylindrical or frusto-conical in shape. Sides 402, 404 and 406 in each respective FIGS. 3a, 3b and 3c, are connected to the base 412 around the perimeter of the base forming a container. The angle between the base 412 and the sides is defined as αₓ. The shapes of the containers are cylindrical, frusto-conical, or inverse frusto-conical based on the angle αₓ.

In FIG. 3a, α₁ is approximately 90 degrees. The container of 3a is the preferred embodiment because it allows both relatively easy addition to and subtraction from the contents of the container.

In FIG. 3b, α₂ is less than 90 degrees. Container 410 is preferred if a material test does not require removal of contents during the preparation or test procedure. This design provides a low center of gravity, a large base and a narrow top of the container limiting splashes even without a lid.

The design of the container 430 in FIG. 3c has an angle α₃ that is greater than 90 degrees. This design is preferred if a test requires removal of contents with a ladle or other similar tool. The design is especially desired if the container must have constant heat during the preparation or testing process. Another feature of this design is that base 412 is narrower than the top.

Preferably, thickness 413 of base 412 is thicker than thickness 415 of sides 414. This increased thickness on the bottom is for structural strength because the bottom of the container typically gets bumped, scratched and hit. The thickness 415 of the sides 414 is thinner than the thickness 413 of the base 412 to save on material costs.

The sides of the container form an internal cavity. In all three designs, at an end of the sides distal from the base-side connection where αₓ is formed, flange 408 is connected to sides 402, 404 and 406 forming a shoulder 409. The flange 408 is preferred so that a lid may be mating placed on the container. The distal ends of the sides of the containers form an opening in the container so that material may be placed in and removed from the internal cavity.

In some cases, container 410 shown in FIG. 3a may also include a coating 414 that is applied to the sides and bottom of the container. It may also be applied to any part of the container that would react with electrolytes or material to be tested so that the container would not react with its contents. The coating is preferably made of Teflon or a silicon based composite, but it may be anything as long as it prevents a reaction between the contents of the container and the container or any part thereof.

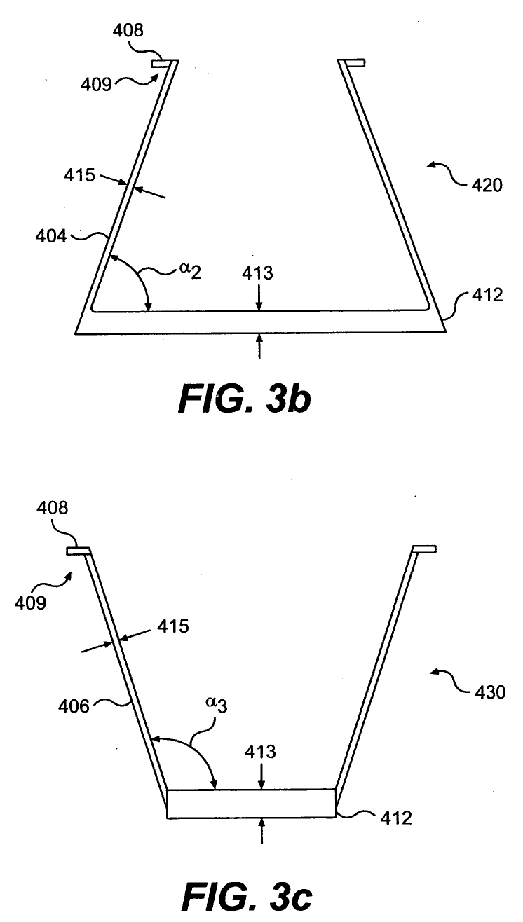

Additionally, the testing container preferably has a handle connected to the container. As shown in various embodiments of FIG. 4, there are many different types of handles that are within the scope of the invention. In FIG. 4a, the handle shown may be formed as part of the container when the container is formed. Alternatively the handle may be attached after the container is formed.

In FIG. 4a, a handle is shown having a first end 202 and a second end 204. The first end 202 is connected to the container preferably to the sides. The second end may be connected to the sides or it may not be as shown in FIG. 4d.

Another type of handle is a removable handle 206. Two types of removable handles are shown in FIGS. 4b and 4c. In FIG. 4b, the removable handle comprises a first piece 208 and a second piece 210 that are connected at pivot point 214. Each of the first piece 208 and the second piece 210 have a first end 218 and a second end 220. Between the first end 218 and the second end 220 is a pivot point connection. At the pivot point connection is the pivot point 214 through which the first piece and second piece are connected so that an openable claw 216 is formed. The claw 216 fits around the container. The second ends 220 of the first and second pieces 208, 210 form a handle 200 to move the container. A spring 212 is operably positioned so that the ends 218 and 220 are biased apart. The spring's resistive force may be overcome so that the claw opens wider than the tube thus allowing the handle to be removably attached. The claw 216, biased closed by the spring 212, fits under the flange or lip of the container so that the container is prevented from slipping not only by friction but also the engagement of the lip with the claw. Similarly, FIG. 4c shows a two part handle that engages one piece 210 under the flange 201 or lip. The second piece 208 is positioned over the flange 201. The second piece is formed so that it holds the first piece 210 under the flange 201.

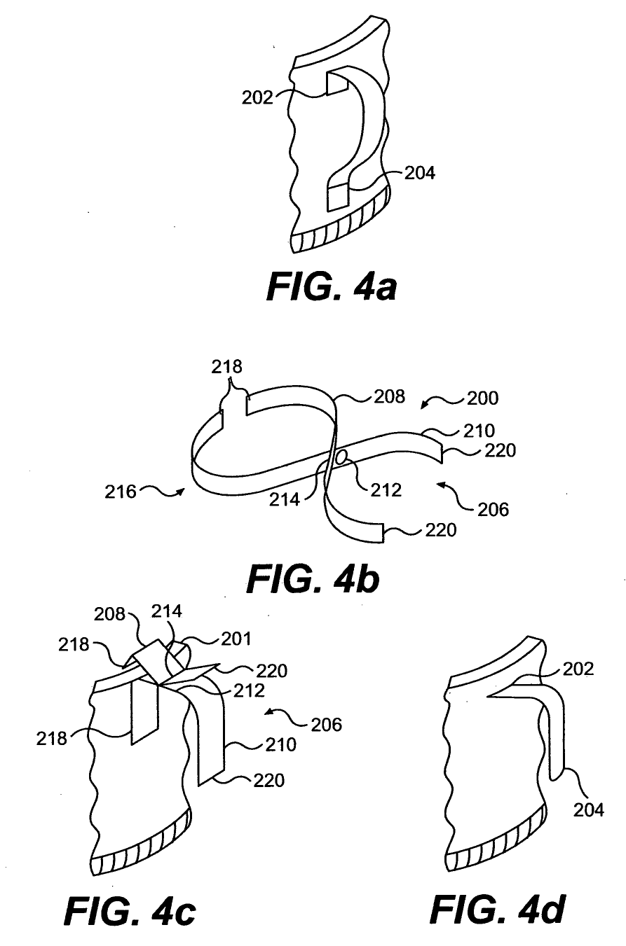

FIG. 5 shows a top view of container 300. It is clear from this view, the flange 408 is connected to the distal end or top of sides 352 of container 300. Preferably a spout 302 is integrally formed in to container 300 when the material is being formed to make the container. The spout may be a variety of shapes and designs that facilitate the pouring of contents of container 300 from the container 300 without spilling. In order to limit drips, a sharp edge 301 should be formed into spout 302.

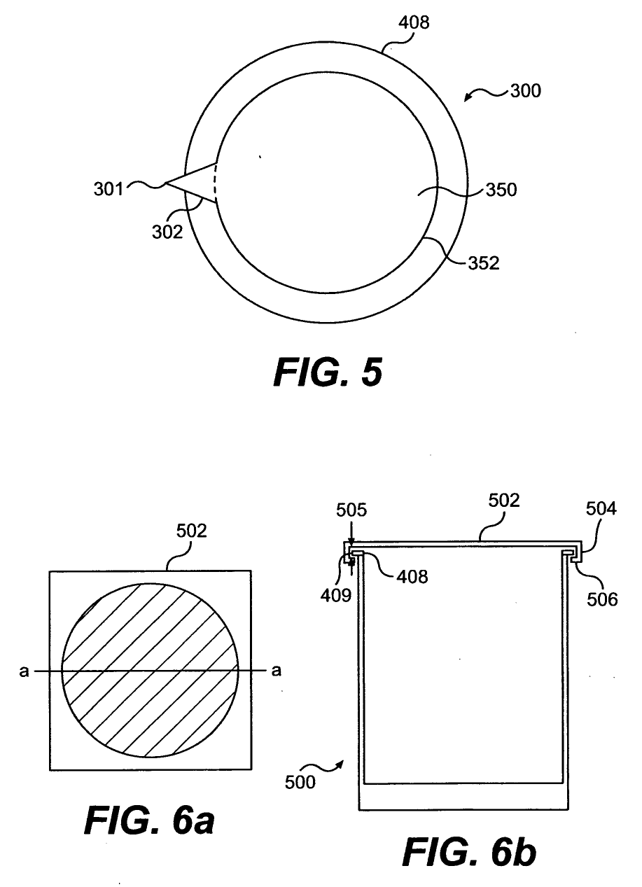

FIGS. 6a and 6b show one embodiment of the container wherein container 500 is equipped with a lid 502. Preferably, the lid is removably attached to the container 500. The lid may be merely set on the container or preferably locked onto the top of the container through a C-channel shaped and flange connection. In this embodiment, lid 502 has a C-channel formed on at least one edge. It is undesirable to have the C-channel formed around the lid's entire perimeter. The flange 408 is connected to the sides of the container 500. Preferably, flange 408 is formed integrally with container 500 when container 500 is formed. The lid 502 may be square, as shown in FIG. 6b or any other shape that performs the same function. The lid 502 slides onto flange 408. Preferably, if the lid 502 is square-shaped, the lid shall have C-channels on 3 sides. If the lid is generally round, the lid preferably has a U-shaped C-channel. By having the channels, the lid is less likely to fall off than a lid that is simply placed on the container. Additionally, the lid may be placed on the container from a plurality of starting positions not just from a direction generally opposite the spout. A lid helps prevent sloshing over, boiling over and splatter by reducing communication from the internal cavity to outside the container. It is also within the scope of this invention to vary the attachment mechanism of the lid to the container as well as putting the flange on the lid and the C-channel on the container.

Although particular step sequences are shown, described, and claimed, it should be understood that steps may be performed in any order, separated or combined unless otherwise indicated and will still benefit from the present invention.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

1. A single piece container of a non-reactive material for high temperature preparation of materials for testing in the presence of an electrolyte.

2. The container according to claim 1, wherein the electrolyte is an acid.

3. The container according to claim 2, wherein the acid is sulfuric acid.

4. The container according to claim 2, wherein the acid is hydrofluoric acid.

5. The container according to claim 2, wherein the acid is perchloric acid.

6. The container according to claim 1, wherein the non-reactive material is a graphite or graphite composite.

7. The container according to claim 6, wherein the container is at least partially covered with a non-reactive coating.

8. The container according to claim 7, wherein the non-reactive coating is Teflon.

9. The container according to claim 6, having a bottom and sides wherein the transition between the bottom and sides is arcuate.

10. A single piece container for holding materials in the presence of acid comprising a base connected to sides of the container forming an internal cavity that contains the materials and acid.

11. The container according to claim 10, wherein the container has a cover.

12. The container according to claim 11, wherein the container has a cover that matingly engages the container with at least one flange and c-channel.

13. The container according to claim 10, wherein the container has a pouring spout.

14. The container according to claim 10, wherein the container has a handle

15. The container according to claim 14, wherein the container has a pouring spout.

16. A single piece container for preparing or testing materials that is resistant to acids and temperature of at least 400 degrees Celsius made of a graphite or graphite composite material having a thermal conductivity of 40 to 120 W/(m*K).

17. The container according to claim 16, wherein the graphite or graphite composite material has a compressive strength in the range of 80 to 150 N/mm².

18. The container according to claim 17, wherein the graphite or graphite composite has a Young's Modulus in the range of 10 to 13*10³ N/mm².

19. The container according to claim 16, wherein the graphite or graphite composite has a bulk density of about 1.7 to 1.9 g/cm³.

20. The container according to claim 16, wherein the graphite or graphite composite is R7510.
